(19) United States
(12) Patent Application Publication
(10) Pub. No.: US 2026/0115710 A1
(43) Pub. Date: Apr. 30, 2026

(54) LAMINATE URINALYSIS ASSAY STRIP AND METHODS OF PRODUCING AND USING SAME

(71) Applicant: Siemens Healthcare Diagnostics Inc., Tarrytown, NY (US)

(72) Inventors: Aaron Kauffmann, Elkhart, IN (US); Lloyd Schulman, Granger, IN (US)

(73) Assignee: Siemens Healthcare Diagnostics Inc., Tarrytown, NY (US)

(21) Appl. No.: 19/151,509

(22) PCT Filed: Jan. 29, 2024
(86) PCT No.: PCT/US2024/013277

§ 371 Date: Jul. 28, 2025

Related U.S. Application Data
(60) Provisional application No. 63/482,916, filed on Feb. 2, 2023.

(51) Int. Cl. B01L 3/00

(52) U.S. Cl. CPC B01L 3/5023; B01L 2200/0684; B01L 2300/0681; B01L 2300/0825; B01L 2300/0864; B01L 2300/0887; B01L 2300/12; B01L 2300/161

(57) ABSTRACT

A laminated test strip device for detecting the presence of a plurality of target analytes in a biological sample is disclosed. The laminated test strip device is formed of a plurality of laminated layers of material that control sample flow and sample metering. Methods of producing and using the laminated test strip device are also disclosed.

### CROSS REFERENCE TO RELATED APPLICATIONS/INCORPORATION BY REFERENCE STATEMENT

This application claims benefit under 35 USC § 119(e) of U.S. Provisional Application No. 63/482,916, filed Feb. 2, 2023. The entire contents of the above-referenced patent application are hereby expressly incorporated herein by reference.

### FEDERALLY SPONSORED RESEARCH OR DEVELOPMENT

Not applicable.

### BACKGROUND OF THE INVENTION

Numerous devices and methods exist for detecting analytes that may be present in a patient's fluid sample, including, for instance, a patient's urine sample. Such devices have been proven to be effective in diagnostic assays that detect the presence (or non-presence) as well as the quantity of certain analytes indicative of a patient's health and biological profile, including, but not limited to, analytes and conditions associated with a patient's urine sample. However, these devices, kits, and methods are limited in their configuration in that current configurations do not easily allow for the testing of a small volume of a patient's fluid (i.e., urine) sample. As a result of this configuration, it is difficult to obtain an accurate analysis of a patient's urine sample when a patient only produces a small volume of a liquid test sample (less than about 5 milliliters). In current test strip configurations, when the volume of a sample is low, the receptacle containing the sample must be manipulated (either manually or via machine) to facilitate the interaction between the analyte(s) of interest and the respective reagent(s) contained on the analyte testing pad(s). This can result in inaccurate and/or incomplete results (due to incomplete wetting of the analyte testing regions by the liquid sample), as well as spillage of the sample from the sample receptacle.

In addition, current configurations include sizable analyte testing pads along the total (or substantially total) length of the urine test strip (which typically have a length of about 11 centimeters), resulting in the need for increased amounts of reagents to be incorporated on each analyte testing pad. Current urinalysis test strips use approximately 15-20 ul of each reagent to produce 0.2″×0.2″ colorimetric pads. These pads are prepared by running paper rolls through troughs of colorimetric reagent, which can result in a substantial loss from dead volume.

Accordingly, a need exists for new and improved devices, kits, and methods that allow for the production of target analyte test strip devices as well as use thereof that can be used with a low-volume of a patient's liquid test sample for detection of a plurality of analytes of interest.

### BRIEF DESCRIPTIONS OF THE DRAWINGS

FIG. 1 is a perspective view of one non-limiting embodiment of a laminated test strip device constructed in accordance with the present disclosure.

FIG. 2 is an exploded view of the various layers of the laminated test strip device of FIG. 1.

FIG. 3 is an exploded view of the various layers of another non-limiting embodiment of laminated test strip device constructed in accordance with the present disclosure.

FIG. 4 is an exploded view of the various layers of yet another non-limiting embodiment of laminated test strip device constructed in accordance with the present disclosure.

FIG. 5 is an exploded view of the various layers of yet another non-limiting embodiment of laminated test strip device constructed in accordance with the present disclosure.

FIG. 6 is an exploded view of the various layers of yet another non-limiting embodiment of laminated test strip device constructed in accordance with the present disclosure.

FIG. 7 depicts a method of using any of the laminated test strip devices of the present disclosure.

### DETAILED DESCRIPTION

Before explaining at least one embodiment of the present disclosure in detail, it is to be understood that the present disclosure is not limited in its application to the details of construction and the arrangement of the components or steps or methodologies set forth in the following description or illustrated in the drawings. The present disclosure is capable of other embodiments or of being practiced or carried out in various ways. Also, it is to be understood that the phraseology and terminology employed herein is for the purpose of description and should not be regarded as limiting in any way.

Independent of the grammatical term usage, individuals with male, female, or other gender identities are included within the term.

Unless otherwise defined herein, scientific and technical terms used in connection with the present disclosure shall have the meanings that are commonly understood by those of ordinary skill in the art. Further, unless otherwise required by context, singular terms shall include pluralities and plural terms shall include the singular. The foregoing techniques and procedures are generally performed according to conventional methods well known in the art and as described in various general and more specific references that are cited and discussed throughout the present specification. The nomenclatures utilized in connection with, and the laboratory procedures and techniques of, analytical chemistry, synthetic organic chemistry, and medicinal and pharmaceutical chemistry described herein are those well-known and commonly used in the art. Standard techniques are used for chemical syntheses and chemical analyses.

All patents, published patent applications, and non-patent publications mentioned in the specification are indicative of the level of skill of those skilled in the art to which the present disclosure pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles, compositions, kits, and/or methods disclosed herein can be made and executed without undue experimentation in light of the present disclosure. While the articles, compositions, kits, and/or methods have been described in terms of particular embodiments, it will be apparent to those of skill in the art that variations may be applied to the articles, compositions, kits, and/or methods and in the steps or in the sequence of steps of the methods described herein without departing from the concept, spirit, and scope of the present disclosure. All such similar substitutes and modifications apparent to those skilled in the art are deemed to be within the spirit, scope, and concept of the present disclosure as defined by the appended claims.

As utilized in accordance with the present disclosure, the following terms, unless otherwise indicated, shall be understood to have the following meanings:

The use of the term “a” or “an” when used in conjunction with the term “comprising” in the claims and/or the specification may mean “one,” but it is also consistent with the meaning of “one or more,” “at least one,” and “one or more than one.” As such, the terms “a,” “an,” and “the” include plural referents unless the context clearly indicates otherwise. Thus, for example, reference to “a compound” may refer to one or more compounds, two or more compounds, three or more compounds, four or more compounds, or greater numbers of compounds. The term “plurality” refers to “two or more.”

The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

The use of the term “or” in the claims is used to mean an inclusive “and/or” unless explicitly indicated to refer to alternatives only or unless the alternatives are mutually exclusive. For example, a condition “A or B” is satisfied by any of the following: A is true (or present) and B is false (or not present), A is false (or not present) and B is true (or present), and both A and B are true (or present).

As used herein, any reference to “one embodiment,” “an embodiment,” “some embodiments,” “one example,” “for example,” or “an example” means that a particular element, feature, structure, or characteristic described in connection with the embodiment is included in at least one embodiment. The appearance of the phrase “in some embodiments” or “one example” in various places in the specification is not necessarily all referring to the same embodiment, for example. Further, all references to one or more embodiments or examples are to be construed as non-limiting to the claims.

Throughout this application, the terms “about” and “approximately” are used to indicate that a value includes the inherent variation of error for a composition/apparatus/device, the method being employed to determine the value, or the variation that exists among the study subjects. That is, the terms “about” and “approximately” and variations thereof are intended to include not only the exact value qualified by the term, but to also include some slight deviations therefrom, such as deviations caused by measuring error, manufacturing tolerances, wear and tear on components or structures, settling or precipitation of cells or particles out of suspension or solution, chemical or biological degradation of solutions over time, stress exerted on structures, and combinations thereof, for example. In particular, for example, but not by way of limitation, when the term “about” is utilized, the designated value may vary by plus or minus twenty percent, or fifteen percent, or twelve percent, or eleven percent, or ten percent, or nine percent, or eight percent, or seven percent, or six percent, or five percent, or four percent, or three percent, or two percent, or one percent from the specified value, as such variations are appropriate to perform the disclosed methods and as understood by persons having ordinary skill in the art.

As used in this specification and claim(s), the words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps. For example, a composition, a process, method, article, or apparatus that comprises a list of elements is not necessarily limited to only those elements but may include other elements not expressly listed or inherently present therein.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

As used herein, the phrases “associated with” and “coupled to” include both direct association/binding of two moieties to one another as well as indirect association/binding of two moieties to one another. Non-limiting examples of associations/couplings include covalent binding of one moiety to another moiety either by a direct bond or through a spacer group, non-covalent binding of one moiety to another moiety either directly or by means of specific binding pair members bound to the moieties, incorporation of one moiety into another moiety such as by dissolving one moiety in another moiety or by synthesis, and coating one moiety on another moiety, for example.

The term “sample” as used herein will be understood to include any type of biological sample that may be utilized in accordance with the present disclosure. Examples of fluidic biological samples that may be utilized include, but are not limited to, whole blood or any portion thereof (i.e., plasma or serum), urine, saliva, sputum, cerebrospinal fluid (CSF), synovial fluid, intestinal fluid, intraperitoneal fluid, cystic fluid, sweat, interstitial fluid, extracellular fluid, tears, mucus, bladder wash, semen, fecal, pleural fluid, nasopharyngeal fluid, combinations thereof, and the like.

As used herein, the term “liquid sample” and variations thereof is intended to include, for example, but not limited to, biological fluids (such as urine and whole blood), chemical fluids, chemical substances, suspensions, solutions, slurries, mixtures, agglomerations, tinctures, slides, or other preparations of biological fluids, synthetic analogs to biological fluids, and combinations thereof.

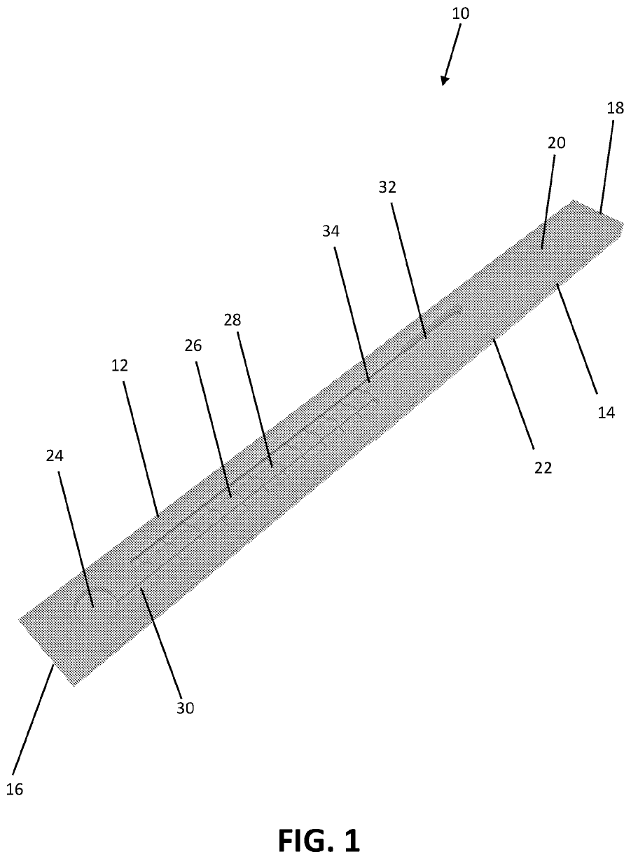

Turning now to the various non-limiting embodiments of the present disclosure, FIG. 1 depicts one non-limiting embodiment of a laminated test strip device 10 constructed in accordance with the present disclosure. The laminated test strip device 10 is used for detecting the presence of a plurality of target analytes in a biological sample and comprises a first side 12, a second side 14, a first end 16, a second end 18, an upper surface 20, and a lower surface 22. In certain embodiments of the presently disclosed and/or claimed inventive concept(s), each of the first side 12 and the second side 14 comprises a length that is substantially longer than a length of each of the first end 16 and the second end 18. By way of example and not by way of limitation, the length of the first side 12 and the second side 14 may be as high as 20 times, 15 times, 10 times, 9 times, 8 times, 7 times, 6 times, 5 times, 4 times, 3 times, or 2 times the length of the first end 16 and the second end 18. In addition, while FIG. 1 depicts the device 10 as being substantially rectangular in shape, it should be understood to a person having ordinary skill in the art that the device 10 can be provided with any shape that will allow the device 10 to function in accordance with the present disclosure.

The laminated test strip device 10 includes at least one sample collection well 24 formed through the upper surface 20, a plurality of sample testing wells 26 that each have at least one colorimetric reagent 28 dispensed therein in a metered volume, and a sample channel 30 connecting the sample collection well 24 to the plurality of sample testing wells 26. The sample channel 30 draws sample from the sample collection well 24 into the plurality of sample testing wells 26 via capillary action for interaction with the colorimetric reagents 28 and performance of individual assays within each of the plurality of sample testing wells 26. The laminated test strip device 10 further includes a venting well 32 for venting air displaced by the sample and a venting channel 34 connecting the plurality of sample testing wells 26 to the venting well 32 so that excess sample can flow through the plurality of sample testing wells 26.

In certain particular (but non-limiting) embodiments, each of the sample channel 30 and the venting channel 34 has a diameter that is at least about twice a diameter of the plurality of sample testing wells 26, to enable capillary action to pull sample into the sample wells 26 and to inhibit progression of sample from the sample wells 26 into the ventilation channel 34. Alternatively, and/or in addition thereto, the sample collection well 24 may optionally include a filter to inhibit debris from entering the sample channel 30. In addition, any of the laminated test strip devices disclosed or otherwise contemplated herein may be provided with hydrophilic or hydrophobic channel surface properties present in the sample channel 30 and/or sample wells 26.

Any of the laminated test strip devices of the present disclosure may be provided with any number of sample testing wells that allow for detection of a desired number of target analytes. In certain particular (but non-limiting) embodiments, the laminated test strip devices contain (for example, but not by way of limitation), at least two, at least three, at least four, at least five, at least six, at least seven, at least eight, at least nine, at least ten, at least eleven, or at least twelve sample testing wells.

In certain non-limiting embodiments, any of the laminated test strip devices of the present disclosure detect the presence of two or more target analytes, such as, but not limited to, at least three, at least four, at least five, at least six, at least seven, at least eight, at least nine, at least ten, at least eleven, or at least twelve analytes. Non-limiting examples of analytes that may be detected in each of the sample testing wells include glucose, bilirubin, ketones, blood, proteins, urobilinogen, nitrites, leukocytes, albumin, creatinine, ascorbic acid, specific gravity, pH, and the like.

The various analytes are detected using one or more colorimetric reagents disposed in the sample testing wells. Non-limiting examples of colorimetric reagents that may be utilized in accordance with the present disclosure include glucose oxidase, peroxidase, potassium iodide, 2,4-dichloroaniline diazonium salt, sodium nitroprusside, bromothymol blue, methyl vinyl ether, maleic anhydride, sodium hydroxide, diisopropylbenzene dihydroperoxide, 3, 3′, 5, 5′-tetramethylbenzidine, methyl red, tetrabromophenol blue, p-diethylamino-benzaldehyde, p-arsanilic acid, 1, 2, 3, 4-tetrahydrobenzo(h)quinolin-3-ol, derivatized pyrrole amino acid ester, bis (3′,3″-diiodo-4′,4″-dihydroxy-5′,5″-dinitrophenyl)-3,4,5,6-tetrabromosulfonepthalein, copper sulfate, diazonium salt, and the like, as well as any combinations thereof.

The at least one colorimetric reagent disposed in each sample testing well may be provided in any form that allows for detection of the corresponding target analyte and thus allows the device to function as described herein. In certain particular (but non-limiting) examples, at least one reagent present in at least one sample well is in the form of a dried reagent. Alternatively, the at least one reagent may be in a liquid form; in a particular (but non-limiting) embodiment, at least one reagent present in at least one sample well is present at a volume of less than or equal to about 2.5 μl (such as, but not limited to, about 2 μl, about 1.5 μl, about 1 μl, about 0.5 μl, about 0.1 μl, about 0.05 μl, about 0.01 μl, and the like, as well as a range formed of any two of the above values (i.e., a range of from about 2.5 μl to about 0.01 μl).

The laminated test strip devices of the present disclosure may be provided with any dimensions that allow the laminated test strip devices to function as described herein. In certain non-limiting embodiments, the device 10 has a width of less than or equal to about 1 cm, such as (but not limited to) about 0.9 cm, about 0.8 cm, about 0.7 cm, about 0.6 cm, about 0.5 cm, about 0.4 cm, about 0.3 cm, about 0.2 cm, about 0.1 cm, and the like, as well as a range formed of two of the above values (i.e., a range of from about 0.3 cm to about 1 cm, etc.).

The laminated test strip devices of the present disclosure may be configured for manual visual interrogation of the sample wells; alternatively, the laminated test strip devices of the present disclosure may be sized, structured, and configured for positioning within a diagnostic instrument for optical interrogation of the sample wells.

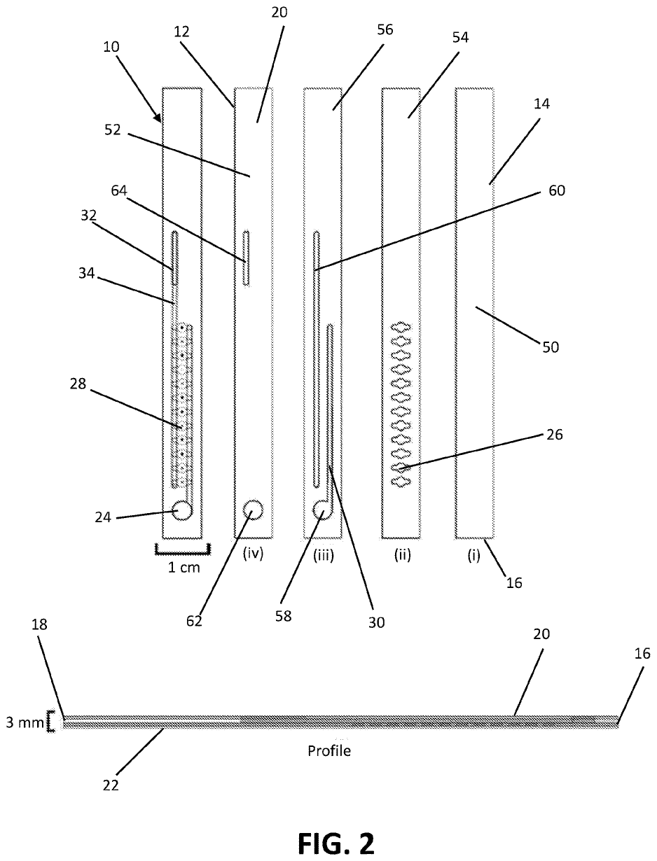

The laminated test strip devices of the present disclosure are formed of a plurality of laminated layers of material that control sample flow and sample metering. Each of the various elements present in the laminated test strip devices of the present disclosure is independently formed in one or more layers of the laminated test strip device. FIGS. 2-5 depict various non-limiting embodiments of laminated test strip devices that demonstrate various configurations of element placement between various layers of the laminated test strip devices.

FIG. 2 illustrates the various layers of the laminated test strip device 10 of FIG. 1 and placement of the various elements within such layers. The assembled laminated test strip device 10 is shown to the left, and the various layers are shown to the right thereof (labeled as (iv), (iii), (ii), and (i), in relation to the claims), starting with the top layer. The laminated test strip device 10 includes a lower substrate layer 50 and an upper substrate layer 52. A lower surface of the lower substrate layer 50 forms the lower surface 22 of the device 10, while an upper surface of the upper layer 52 forms the upper surface 20 of the device 10. The laminated test strip devices of the present disclosure can have multiple interior layers between the lower substrate layer 50 and the upper substrate layer 52. In the laminated test strip device 10 shown in FIG. 2, there are two interior layers between the upper and lower substrate layers 52 and 50: a first interior layer 54 and a second interior layer 56. The first interior layer 54 is disposed above the lower substrate layer 50, while the second interior layer 56 is disposed between the first interior layer 54 and the upper substrate layer 52.

In the laminated test strip device 10 of FIGS. 1-2, the first interior layer 54 has a plurality of grooves, apertures, or openings formed therein that provide the plurality of sample testing wells 26. The second interior layer 56 has an opening 58, at least a portion of which is formed therethrough; the opening 58 forms the sample channel 30 and a portion of the sample collection well 24. The second interior layer 56 also has an opening 60, at least a portion of which is formed therethrough; the opening 60 that forms the venting channel 34 and a portion of the venting well 32. The upper substrate layer 52 has an opening 62 formed therein that overlaps with a portion of the opening 58 in the second interior layer 56; the overlapping portions of the openings 58 and 62 form the sample collection well 24. The upper substrate layer 52 also has an opening 64 formed therethrough that overlaps with a portion of the opening 60, and the overlapping portions of the openings 60 and 64 form the venting well 32.

In this manner, the sample collection well 24 is formed through the upper surface 20 of the device 10 and extends into at least the second interior layer 56, where it connects to the sample channel 30. This allows the sample channel 30 to draw sample from the sample collection well 24 into the plurality of sample testing wells 26 in the first interior layer 54 via capillary action. Then excess sample is pulled through the plurality of sample testing wells 26.

While FIG. 2 illustrates the laminated test strip device 10 as being formed of four layers, it will be understood that the laminated test strip device 10 may be formed of more than four layers, so long as the placement of the various elements between the multiple layers involves the following: (1) the elements are positioned between the various layers such that all of the elements are in fluidic communication with one another and are positioned to provide a substantially unidirectional sample flow path that includes the sample collection well(s), the sample channel, the plurality of sample testing wells, the venting channel, and the venting well(s); (2) at least a portion of the sample collection well(s) must be formed in the upper substrate layer and extend through the upper surface of the device; (3) the sample collection well(s) and sample channel should be formed in layer(s) above the layer in which the plurality of sample testing wells is formed; (4) the layer containing the plurality of sample testing wells is substantially free of any of the other elements (i.e., sample collection well(s), sample channel, venting channel, and venting well(s)) (although a small portion of one element could be present on this layer); (5) the venting channel and venting well(s) can be formed in layers above or below the plurality of sample testing wells; (6) at least a portion of the venting well(s) must be formed in either the upper or lower substrate layer so that the venting well(s) extend through the upper or lower surface of the device (thereby enabling displaced air to be vented from the device); and (7) at least a portion of the sample collection well(s), sample channel, venting channel, and venting well(s) can be formed in the same layer as one or more of the sample collection well(s), sample channel, venting channel, and venting well(s).

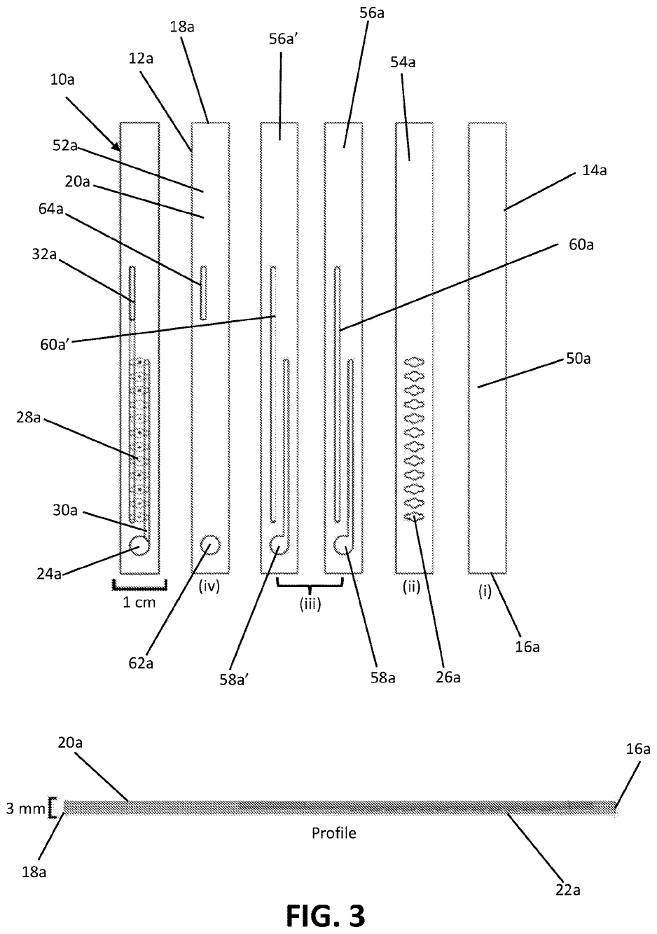

For example (but not by way of limitation), FIG. 3 illustrates a laminated test strip device 10a that is similar to the device 10 of FIGS. 1-2, except that the device 10a is formed of five layers of material. The device 10a includes an upper substrate layer 52a, a lower substrate layer 50a, and a first interior layer 54a; however, the second interior layer is formed of two layers 56a and 56a′. The first interior layer 54a has a plurality of grooves, apertures, or openings formed therein that provide the plurality of sample testing wells 26a. The upper substrate layer 52a has an opening 62a and an opening 64a formed therein. Similar to the second interior layer 56 of the device 10 of FIG. 2, each of the layers 56a and 56a′ has an opening 58a/58a′ formed therethrough; together, the openings 58a and 58a′ form the sample channel 30a and a portion of the sample collection well 24a. Also similar to the second interior layer 56 of the device 10 of FIG. 2, each of the layers 56a and 56a′ has an opening 60a/60a′ formed therethrough; together, the openings 60a and 60a′ form the venting channel 34a and a portion of the venting well 32a. The opening 62a in the upper substrate layer 52a overlaps with a portion of the openings 58a and 58a′, and the overlapping portions of the openings 58a, 58a′, and 62a form the sample collection well 24a. The opening 64a in the upper substrate layer 52a overlaps with a portion of the openings 60a and 60a′, and the overlapping portions of the openings 60a, 60a′, and 64a form the venting well 32a.

In this manner, the sample collection well 24a is formed through the upper surface 20a of the device 10a and extends into the layers 56a and 56a′, where it connects to the sample channel 30a. This allows the sample channel 30a to draw sample from the sample collection well 24a into the plurality of sample testing wells 26a in the first interior layer 54a via capillary action. Then excess sample is pulled through the plurality of sample testing wells 26a into the venting channel 34a and into the venting well 32a.

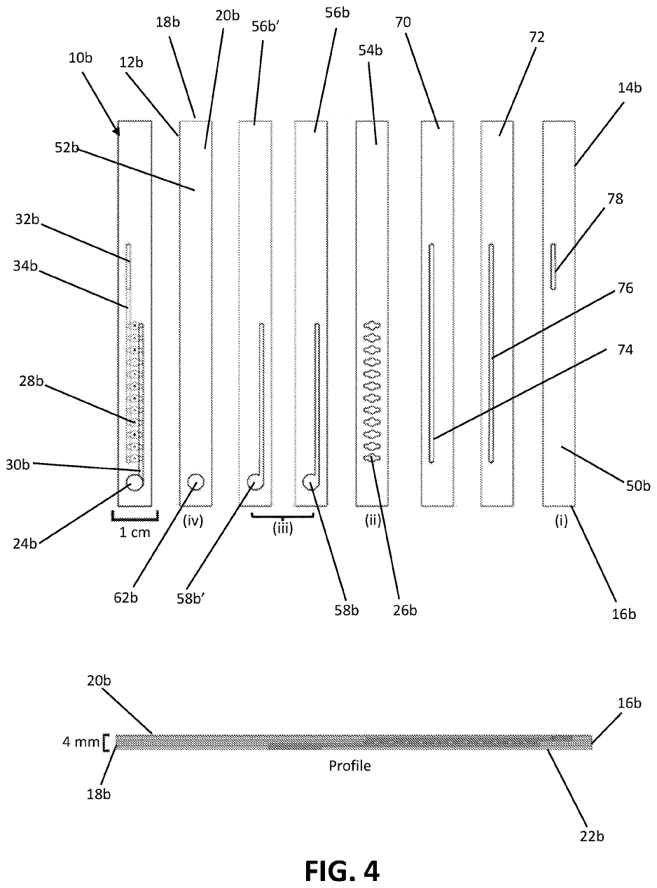

In yet another non-limiting example, FIG. 4 illustrates a laminated test strip device 10b that is similar to the device 10a of FIG. 3, except that the device 10b is formed of seven layers of material. The device 10b includes an upper substrate layer 52b, a lower substrate layer 50b, a first interior layer 54b, along with a second interior layer formed of two layers 56b and 56b′, as in the device 10a of FIG. 3. The device 10b also includes two additional interior layers 70 and 72 disposed between the lower substrate layer 50b and the first interior layer 54b (i.e., between the lower surface 22b of the device 10b and the plurality of sample testing wells 26b). The first interior layer 54b has a plurality of grooves, apertures, or openings formed therein that provide the plurality of sample testing wells 26b. The upper substrate layer 52b has an opening 62b formed therein. Each of the layers 56b and 56b ′ has an opening 58b/58b′ formed therethrough; together, the openings 58b and 58b ′ form the sample channel 30b, and the opening 62b and a portion of the openings 58b and 58b ′ form the sample collection well 24b. However, in contrast to the devices 10 and 10a, where the venting channel and venting well are formed in layers above the layer in which the sample collection wells are formed, in the device 10b, the venting channel 34b and venting well 32b are formed in the additional layers below the layer in which the sample collection wells are formed. That is, layer 70 has an opening 74 formed therein, and layer 72 has an opening 76 formed therein, where the opening 74 and 76 at least partially overlap with one another and form the venting channel 34b and a portion of the venting well 32b. In addition, the lower substrate layer 50b has a groove 78 formed therein that at least partially overlaps with the openings 74 and 76; these overlapping portions of openings 74 and 76 and groove 32b form the venting well 32b.

In this manner, the sample collection well 24b is formed through the upper surface 20b of the device 10b and extends into the layers 56b′ and 56b, where it connects to the sample channel 30b. This allows the sample channel 30b to draw sample from the sample collection well 24b into the plurality of sample testing wells 26b in the first interior layer 54b via capillary action. Then excess sample is pulled through the plurality of sample testing wells 26b into the venting channel 34b and into the venting well 32b.

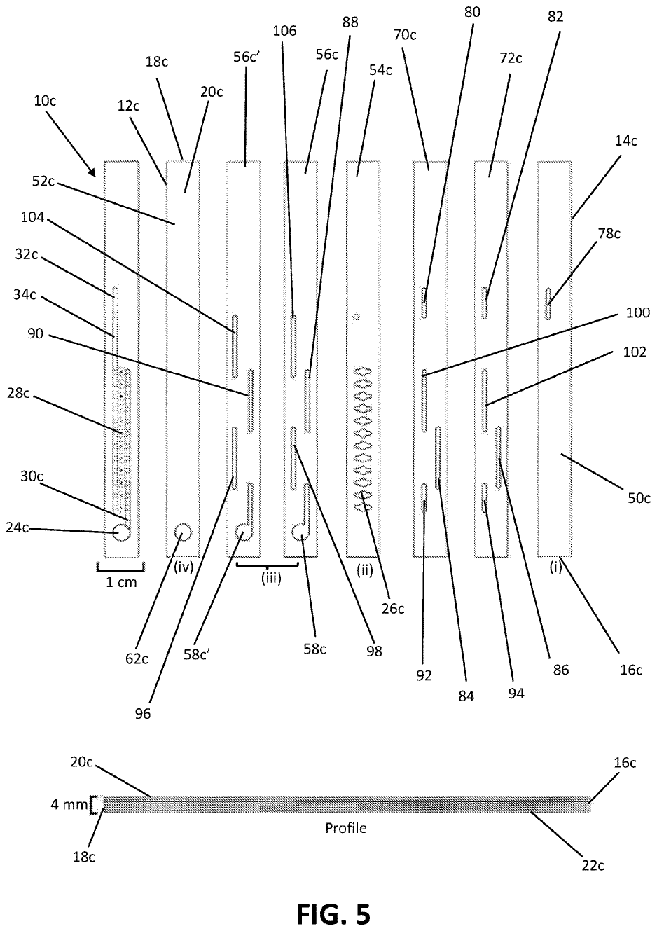

While FIGS. 3-4 depicts the depth of the sample channel and/or the venting channel as being split between layers (i.e., each layer containing an entire length of the channel but only a portion of the depth of such channel), it will be understood that the depth as well as the length of either channel may be split between layers. That is, two or more layers may be provided with openings therein that are each less than a full length of a channel and that only partially overlap with one another; in this manner, the full length of the channel is formed once the layers are connected to one another. For example (but not by way of limitation), FIG. 5 illustrates a laminated test strip device 10c in which only a portion of the length of the sample channel 34c is present in a particular layer, and in which only a portion of the length of the venting channel 34c is present in a particular layer.

The device 10c includes an upper substrate layer 52c, a lower substrate layer 50c, a first interior layer 54c, along with a second interior layer formed of two layers 56c and 56c′, and two additional interior layers 70c and 72c disposed between the lower substrate layer 50c and the first interior layer 54c (i.e., between the lower surface 22c of the device 10c and the plurality of sample testing wells 26c). The first interior layer 54c has a plurality of grooves, apertures, or openings formed therein that provide the plurality of sample testing wells 26c. The upper substrate layer 52c has an opening 62c formed therein, and the lower substrate layer 50c has a groove 78c formed therein. Each of the layers 56c and 56c ′ has an opening 58c/58c′ formed therethrough; together, the openings 62c, 58c′, and 58c form the sample collection well 24c. In addition, each of the layers 70c and 72c has an opening 80/82 formed therethrough that overlap with one another and also overlap with the groove 78c in the lower substrate layer 50c; together, the openings 80 and 82 and the groove 78c form the venting well 32c. However, in contrast to the previously disclosed devices, the device 10c includes multiple openings in the layers 56c′, 56c, 70, and 72 that are spatially distributed along the lengths of the layers and that each partially overlap with at least one other opening to form each of the sample channel 30c and the venting channel 34c. That is, openings 84 and 86 are formed in layers 70c and 72c, respectively, and partially overlap with a terminal end of the openings 58c′ and 58c in layers 56c′ and 56c; then, openings 88 and 90 are formed in layers 56c and 56c′, respectively, and partially overlap with a terminal end of the openings 84 and 86 opposite the ends thereof that overlap with the openings 58c and 58c ′. Together, the openings 58c ′, 58c, 84, 86, 88, and 90 form the sample channel 30c . Similarly, openings 92 and 94 are formed in layers 70c and 72c, respectively. Openings 96 and 98 are formed in layers 56c ′ and 56c, respectively, and partially overlap with a terminal end of the openings 92 and 94. Openings 100 and 102 are formed in layers 80 and 82, respectively, and partially overlap with a terminal end of the openings 96 and 98 opposite the ends thereof that overlap with the openings 92 and 94. Then, openings 104 and 106 are formed in layers 56c ′ and 56c, respectively, and partially overlap with a terminal end of the openings 100 and 102 opposite the ends thereof that overlap with the openings 96 and 98. Together, the openings 92, 94, 96, 98, 100, 102, 104, and 106 form the venting channel 34c.

Each of the layers of any of the laminated test strip devices disclosed or otherwise contemplated herein may be formed of any material, so long as the laminated test strip devices formed therefrom is capable of functioning as described herein. Non-limiting examples of materials from which each layer may be independently selected include acrylic, polystyrene, styrene-acrylonitrile, polycarbonate, polyethylene terephthalate, and the like, as well as any combinations thereof.

In addition, all of the layers above the layer in which the plurality of sample testing wells is disposed must be formed of a transparent material, so that the plurality of sample testing wells can be viewed through the top of the laminated test strip devices. In contrast, the layer containing the plurality of sample testing wells, as well as any layers below said layer, may be formed of a transparent, semi-transparent, semi-opaque, or opaque material.

Each of the layers of the any of the laminated test strip devices disclosed or otherwise contemplated herein may be provided with any thickness, so long as the laminated test strip device formed therefrom is provided with a desired thickness that allows for the conductance of the plurality of analyte assays. For example (but not by way of limitation), each of the layers may have a thickness independently selected from about 0.1 mm, about 0.2 mm, about 0.3 mm, about 0.4 mm, about 0.5 mm, about 0.6 mm, about 0.7 mm, about 0.8 mm, about 0.9 mm, about 1 mm, and the like, as well as a thickness that falls within a range of two of the above values (i.e., a range of from about 0.1 mm to about 1 mm, etc.). In addition, the laminated test strip devices of the present disclosure may be provided with any total thickness, so long as the laminated test strip device is capable of performing the plurality of analyte assays. For example (but not by way of limitation), the laminated test strip devices may be provided with a total thickness of about 0.4 mm, about 0.5 mm, about 0.6 mm, about 0.7 mm, about 0.8 mm, about 0.9 mm, about 1.0 mm, about 1.1 mm, about 1.2 mm, about 1.3 mm, about 1.4 mm, about 1.5 mm, about 1.6 mm, about 1.7 mm, about 1.8 mm, about 1.9 mm, about 2.0 mm, about 2.1 mm, about 2.2 mm, about 2.3 mm, about 2.4 mm, about 2.5 mm, about 2.6 mm, about 2.7 mm, about 2.8 mm, about 2.9 mm, about 3.0 mm, about 3.1 mm, about 3.2 mm, about 3.3 mm, about 3.4 mm, about 3.5 mm, about 3.6 mm, about 3.7 mm, about 3.8 mm, about 3.9 mm, about 4 mm, and the like, as well as a total thickness that falls within a range of two of the above values (i.e., a range of from about 0.4 mm to about 4 mm, etc.).

The laminated test strip devices of the present disclosure are configured for use with fluidic biological samples, to enable detection of a plurality of target analytes within the fluidic biological sample. Any fluidic biological sample capable of flowing through the flow path of the laminated test strip devices of the present disclosure may be utilized in the methods disclosed herein. Non-limiting examples of fluidic biological samples that may be utilized in accordance with the present disclosure include urine, whole blood or any portion thereof (i.e., plasma or serum), synovial fluid, saliva, sputum, cerebrospinal fluid (CSF), intestinal fluid, intraperitoneal fluid, cystic fluid, sweat, interstitial fluid, extracellular fluid, tears, mucus, bladder wash, semen, fecal, pleural fluid, nasopharyngeal fluid, and the like, as well as any combinations thereof.

In certain particular (but non-limiting) embodiments, the laminated test strip devices of the present disclosure include laminated urinalysis test strip devices.

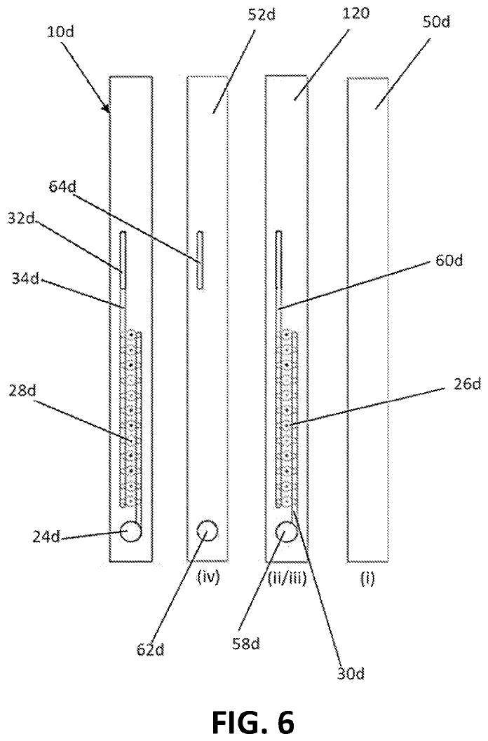

While the laminated test strip devices described herein above are constructed of at least four layers, it will be understood that the interior layers can be combined into a single layer such that the laminated test strip device only includes three layers. That is, the interior layers (ii) and (iii) can be combined into a single layer. FIG. 6 depicts a laminated test strip device 10d that includes a lower substrate layer 50d, a top layer 52d, and a single interior layer 120 that includes all of the features described herein above for layers (ii) and (iii) (and thus is designated as a combined layer (ii)/(iii) herein). Specifically, the single interior layer 120 has an opening or groove 58d formed therein that provides the sample channel 30d and a portion of the sample collection well 24d. The single interior layer 120 has a plurality of grooves, apertures, or openings formed therein that provide the plurality of sample testing wells 26d. The single interior layer 120 also has an opening or groove 60d formed therein that provides the venting channel 34d and a portion of the venting well 32d. In addition, the upper substrate layer 52d has an opening 62d formed therein that overlaps with a portion of the opening 58d in the single interior layer 120, and these overlapping portions form the sample collection well 24d. Similarly, the upper substrate layer 52d also has an opening 64d formed therethrough that overlaps with a portion of the opening 60d, and these overlapping portions form the venting well 32d.

Portions of each of the laminated test strip devices of the present disclosure may be sized and dimensioned (or provided with one or more additional elements) to ensure that sufficient levels of sample are retained in each of the sample testing wells. For example (but not by way of limitation), the venting channel (and optionally the sample channel) may be provided with a channel diameter that is sufficiently larger than the plurality of sample testing wells to enable capillary action to pull sample into the sample testing wells and to inhibit progression of sample from the sample testing wells into the ventilation channel. In particular (but not by way of limitation), the interior layer 56 of FIG. 2 may be formed of a material that is sufficiently thicker than the interior layer 54 (or the sample testing wells 26), to ensure that the diameter of the venting channel 34 (and optionally the diameter of the sample channel 30) is sufficiently larger than the diameter of the sample testing wells 26. Also, the formation of the venting channel 34a in FIG. 3 via the openings 60a and 60a′ in layers 56a and 56a′ provides a sufficiently larger diameter than the sample testing wells 26a; similar results are obtained by the formation of the venting channel 34b in FIG. 4 via the openings 74 and 76 in layers 70 and 72, and by the formation of the venting channel 34c in FIG. 5 via openings 92, 94, 96, 98, 100, 102, 104, and 106 in the four layers 56c, 56c′, 70c, and 72c.

If the venting channel is not provided with a larger diameter than the diameter of the sample testing wells, either through the use of thicker layers and/or multiple layers, then one or more additional elements may need to be present to provide weakened capillary action and thus inhibit progression of too much sample from the sample testing wells into the ventilation channel. For example (but not by way of limitation), the interior layer 54 of FIG. 2 may need to have a fluidic barrier such as a chemical change of the surface′s hydrophilic/phobic properties, or the addition of a plug (such as, but not limited to, a starch plug) to prevent a required amount of sample from flowing past the reagent wells and into the venting channel.

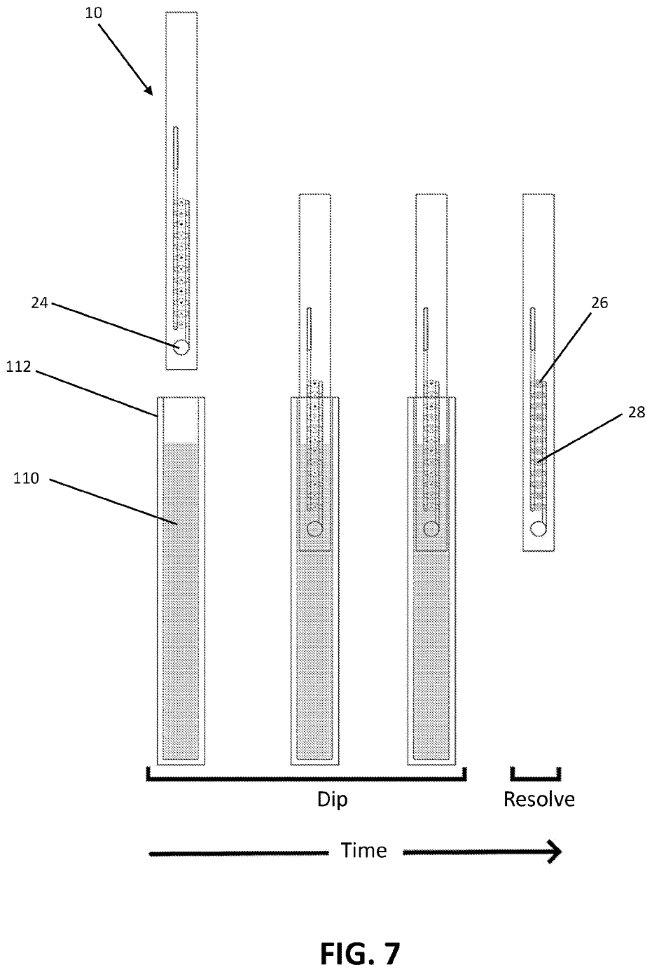

FIG. 7 illustrates use of the laminated test strip device 10 with a fluidic biological sample 110. While the laminated test strip device 10 is shown for ease of reference, it will be understood that any of laminated test strip devices 10a-10d can be used in the same manner. As can be seen, the laminated test strip device 10 is partially inserted into a reservoir 112 that contains the fluidic biological sample 110, so that the fluidic biological sample becomes disposed in the sample collection well 24. The laminated test strip device 10 need only be inserted into the fluidic sample 110 to a depth that allows for sufficient uptake of the fluidic biological sample 110 by the sample collection well 24; however, the laminated test strip device 10 may be inserted into the sample 110 at basically any further depth, as all other elements of the laminated test strip device 10 (with the possible exception of the venting well 32) are protected within the laminated layers of the device 10 and thus do not directly contact the fluidic biological sample 110 except through the flow path of the device 10. However, if the venting well 32 extends through the upper surface 20 of the device 10, then the device 10 should not be immersed into the sample 110 so far that the venting well 32 is submerged.

Following immersion of the device 10 into the fluidic sample 110, the sample 110 traverses the flow path within the device 10 to the plurality of sample testing wells 26, so that any analyte present in the sample 110 can interact with the various colorimetric reagents 28 present in the sample testing wells 26. The presence of at least one target analyte in the sample 110 is determined when a colorimetric result is observed at one or more of the sample wells 26.

The determination step may be performed manually by visual interrogation of the sample wells 26 to identify any colorimetric results that signal the presence of target analyte. Alternatively, the laminated test strip device 10 may be positioned in a diagnostic instrument the sample wells 26 optically interrogated by the diagnostic instrument to identify any colorimetric results that signal the presence of target analyte.

The devices, kits, and methods of the present disclosure allow, by way of example and not by way of limitation, for: (1) the improved detection of the presence (or non-presence) of a plurality of analytes of interest that may be present in a low-volume of a patient′s liquid test sample; (2) the improved detection of the presence (or non-presence) of the plurality of analytes of interest present in samples of patient populations that produce low-volumes of liquid test sample output (including, but not limited to, newborns, infants, toddlers, young adults, adults, and elderly populations, as well as persons suffering from conditions that restrict urine output, such as dehydration, kidney disease, urethral strictures, and obstructive uropathies); (3) the ability to incorporate smaller and more numerous analyte testing sites on the test strip to thereby increase the number of analytes that can be detected in a low-volume of a patient′s liquid test sample; and (4) a reduction in the manufacturing costs associated with the production of such test strips due to a decrease in the amount reagent(s) and materials needed to conduct such diagnostic tests. It is to such devices and methods, as well as kits related thereto, that the presently disclosed and claimed inventive concept(s) is directed.

### NON-LIMITING ILLUSTRATIVE EMBODIMENTS

The following is a list of non-limiting illustrative embodiments disclosed herein:

Illustrative embodiment 1. A laminated test strip device for detecting the presence of a plurality of target analytes in a biological sample, wherein the laminated test strip device is formed of a plurality of laminated layers of material that control sample flow and sample metering, the device comprising: (i) a lower substrate layer, wherein a lower surface of the lower substrate layer forms a lower surface of the device; (ii) at least a first interior layer; (iii) at least a second interior layer; (iv) an upper layer, wherein an upper surface of the upper layer forms an upper surface of the device; (v) at least one sample collection well formed through the upper surface of (iv) and extending into (iii); (vi) a plurality of sample testing wells, each having at least one colorimetric reagent dispensed therein in a metered volume, wherein the plurality of sample testing wells is formed within (ii); (vii) a sample channel connecting (v) and (vi), wherein at least a portion of the sample channel is formed in (iii), and wherein the sample channel draws sample from the sample collection well into the plurality of sample testing wells via capillary action; (viii) a venting well for receiving displaced air; (ix) a venting channel connecting (vi) to (viii); wherein at least a portion of each of (viii) and (ix) is independently formed in one or more layers other than (ii).

Illustrative embodiment 2. The device of illustrative embodiment 1, wherein at least a portion of (ix) is formed in layer (iii), and wherein at least a portion of (viii) is formed in layer (iii) and/or (iv).

Illustrative embodiment 3. The device of illustrative embodiment 1 or 2, wherein (iii) comprises at least two layers, and wherein at least a portion of (ix) is formed in both of the at least two layers of (iii), and wherein at least a portion of (viii) is formed in one or more of layer (iv) and the at least two layers of (iii).

Illustrative embodiment 4. The device of any of illustrative embodiments 1-3, further defined as comprising at least one additional interior layer between layers (i) and (ii).

Illustrative embodiment 5. The device of illustrative embodiment 4, wherein at least a portion of (vii), (viii), and/or (ix) is formed in the at least one additional layer between (i) and (ii).

Illustrative embodiment 6. The device of any of illustrative embodiments 15, wherein at least layers (iii) and (iv) are formed of a substantially transparent material.

Illustrative embodiment 7. The device of any of illustrative embodiments 16, wherein each layer has a thickness in a range of from about 0.1 mm to about 1 mm.

Illustrative embodiment 8. The device of any of illustrative embodiments 17, wherein the device has a total thickness in a range of from about 0.4 mm to about 4 mm.

Illustrative embodiment 9. The device of any of illustrative embodiments 18, wherein each of layers (iii) and (iv) is formed of a material independently selected from the group consisting of acrylic, polystyrene, styrene-acrylonitrile, polycarbonate, polyethylene terephthalate, and any combination thereof.

Illustrative embodiment 10. The device of any of illustrative embodiments 1-9, wherein the device is configured for use with a fluidic biological sample selected from the group consisting of urine, whole blood or any portion thereof, synovial fluid, saliva, sputum, cerebrospinal fluid (CSF), intestinal fluid, intraperitoneal fluid, cystic fluid, sweat, interstitial fluid, extracellular fluid, tears, mucus, bladder wash, semen, fecal, pleural fluid, nasopharyngeal fluid, and combinations thereof.

Illustrative embodiment 11. The device of illustrative embodiment 10, further defined as a laminated urinalysis test strip device.

Illustrative embodiment 12. The device of any of illustrative embodiments 1-11, wherein the plurality of target analytes comprises at least two analytes, wherein each of the at least two analytes is selected from the group consisting of glucose, bilirubin, ketones, blood, proteins, urobilinogen, nitrites, leukocytes, albumin, creatinine, ascorbic acid, specific gravity, and pH.

Illustrative embodiment 12A. The device of any of illustrative embodiments 1-11, wherein the plurality of target analytes comprises at least three, at least four, at least five, at least six, at least seven, at least eight, at least nine, at least ten, at least eleven, or at least twelve analytes.

Illustrative embodiment 12B. The device of illustrative embodiment 12A, wherein each of the analytes is selected from the group consisting of glucose, bilirubin, ketones, blood, proteins, urobilinogen, nitrites, leukocytes, albumin, creatinine, ascorbic acid, specific gravity, and pH.

Illustrative embodiment 13. The device of any of illustrative embodiments 1-12B, wherein (vi) is further defined as comprising at least 12 sample wells.

Illustrative embodiment 14. The device of any one of illustrative embodiments 1-13, wherein at least one colorimetric reagent present in at least one of the plurality of sample testing wells is selected from the group consisting of glucose oxidase, peroxidase, potassium iodide, 2,4-dichloroaniline diazonium salt, sodium nitroprusside, bromothymol blue, methyl vinyl ether, maleic anhydride, sodium hydroxide, diisopropylbenzene dihydroperoxide, 3, 3′, 5, 5′-tetramethylbenzidine, methyl red, tetrabromophenol blue, p-diethylamino-benzaldehyde, p-arsanilic acid, 1, 2, 3, 4-tetrahydrobenzo(h) quinolin-3-ol, derivatized pyrrole amino acid ester, bis (3′,3″-diiodo-4′,4″-dihydroxy-5′,5″-dinitrophenyl)-3,4,5,6-tetrabromosulfonepthalein, copper sulfate, and diazonium salt, or combinations thereof.

Illustrative embodiment 14A. The device of any one of illustrative embodiments 1-13, wherein the at least one colorimetric reagent present in at least two, at least three, at least four, at least five, at least six, at least seven, at least eight, at least nine, at least ten, at least eleven, or at least twelve of the plurality of sample testing wells is each independently selected from the group consisting of glucose oxidase, peroxidase, potassium iodide, 2,4-dichloroaniline diazonium salt, sodium nitroprusside, bromothymol blue, methyl vinyl ether, maleic anhydride, sodium hydroxide, diisopropylbenzene dihydroperoxide, 3, 3′, 5, 5′-tetramethylbenzidine, methyl red, tetrabromophenol blue, p-diethylamino-benzaldehyde, p-arsanilic acid, 1, 2, 3, 4-tetrahydrobenzo(h) quinolin-3-ol, derivatized pyrrole amino acid ester, bis (3′,3″-diiodo-4′,4″-dihydroxy-5′,5″-dinitrophenyl)-3,4,5,6-tetrabromosulfonepthalein, copper sulfate, and diazonium salt, or combinations thereof.

Illustrative embodiment 15. The device of any of illustrative embodiments 1-14A, wherein the device is structured and configured for positioning within a diagnostic instrument for optical interrogation of the sample wells.

Illustrative embodiment 16. The device of any of illustrative embodiments 1-15, wherein the at least one reagent present in at least one sample well is present at a volume of less than or equal to about 2.5 μl.

Illustrative embodiment 17. The device of any of illustrative embodiments 1-16, wherein the at least one reagent present in at least one sample well is in the form of a dried reagent.

Illustrative embodiment 18. The device of any of illustrative embodiments 1-17, wherein each of (vii) and (ix) has a diameter that is at least about twice a diameter of (vi), to enable capillary action to pull sample into the sample wells and to inhibit progression of sample from the sample wells into the ventilation channel.

Illustrative embodiment 19. The device of any of illustrative embodiments 1-18, wherein (v) comprises a filter to inhibit debris from entering (vii).

Illustrative embodiment 20. The device of any of illustrative embodiments 1-19, wherein the device has a width of less than or equal to about 1 cm.

Illustrative embodiment 21. The device of any of illustrative embodiments 1-20, wherein hydrophilic/phobic channel surface properties are present in the sample channel and sample wells.

Illustrative embodiment 22. A method of determining the presence of at least one target analyte in a fluidic biological sample, comprising the steps of: inserting a fluidic biological sample into the at least one sample collection well of the device of any of illustrative embodiments 1-21 and allowing the fluidic biological sample to flow through the device to the plurality of sample testing wells; and determining that at least one target analyte is present in the fluidic biological sample when a colorimetric result is observed at the sample well for the target analyte.

Illustrative embodiment 23. The method of illustrative embodiment 22, wherein the determining step is performed manually.

Illustrative embodiment 24. The method of illustrative embodiment 22, further comprising the step of positioning the device into a diagnostic instrument, and wherein the determining step comprises optical interrogation of the sample wells by the diagnostic instrument.

Illustrative embodiment 25. The method of any of illustrative embodiments 22-24, wherein the fluidic biological sample is selected from the group consisting of urine, whole blood or any portion thereof, synovial fluid, saliva, sputum, cerebrospinal fluid (CSF), intestinal fluid, intraperitoneal fluid, cystic fluid, sweat, interstitial fluid, extracellular fluid, tears, mucus, bladder wash, semen, fecal, pleural fluid, nasopharyngeal fluid, and combinations thereof.

Illustrative embodiment 26. A laminated test strip device for detecting the presence of a plurality of target analytes in a biological sample, wherein the laminated test strip device is formed of a plurality of laminated layers of material that control sample flow and sample metering, the device comprising: (a) a lower substrate layer, wherein a lower surface of the lower substrate layer forms a lower surface of the device; (b) at least one interior layer; and (c) an upper layer, wherein an upper surface of the upper layer forms an upper surface of the device; (d) at least one sample collection well formed through the upper surface of (c) and extending into (b); (e) a plurality of sample testing wells, each having at least one colorimetric reagent dispensed therein in a metered volume, wherein the plurality of sample testing wells is formed within (b); (f) a sample channel connecting (d) and (e), wherein at least a portion of the sample channel is formed in (b), and wherein the sample channel draws sample from the sample collection well into the plurality of sample testing wells via capillary action; (g) a venting well for receiving displaced air, wherein at least a portion of the venting well is formed in (b); and (h) a venting channel connecting (e) to (g).

Illustrative embodiment 27. The device of illustrative embodiment 26, wherein the venting well is formed in at least a portion of (b) and/or (c).

Illustrative embodiment 28. The device of illustrative embodiment 26 or 27, wherein at least layer (c) is formed of a substantially transparent material.

Illustrative embodiment 29. The device of any of illustrative embodiments 26-28, wherein each layer has a thickness in a range of from about 0.1 mm to about 1 mm.

Illustrative embodiment 30. The device of any of illustrative embodiments 26-29, wherein the device has a total thickness in a range of from about 0.4 mm to about 4 mm.

Illustrative embodiment 31. The device of any of illustrative embodiments 26-30, wherein each of layers (b) and (c) is formed of a material independently selected from the group consisting of acrylic, polystyrene, styrene-acrylonitrile, polycarbonate, polyethylene terephthalate, and any combination thereof.

Illustrative embodiment 32. The device of any of illustrative embodiments 26-31, wherein the device is configured for use with a fluidic biological sample selected from the group consisting of urine, whole blood or any portion thereof, synovial fluid, saliva, sputum, cerebrospinal fluid (CSF), intestinal fluid, intraperitoneal fluid, cystic fluid, sweat, interstitial fluid, extracellular fluid, tears, mucus, bladder wash, semen, fecal, pleural fluid, nasopharyngeal fluid, and combinations thereof.

Illustrative embodiment 33. The device of illustrative embodiment 32, further defined as a laminated urinalysis test strip device.

Illustrative embodiment 34. The device of any of illustrative embodiments 26-33, wherein the plurality of target analytes comprises at least two analytes, wherein each of the at least two analytes is selected from the group consisting of glucose, bilirubin, ketones, blood, proteins, urobilinogen, nitrites, leukocytes, albumin, creatinine, ascorbic acid, specific gravity, and pH.

Illustrative embodiment 34A. The device of any of illustrative embodiments 26-33, wherein the plurality of target analytes comprises at least three, at least four, at least five, at least six, at least seven, at least eight, at least nine, at least ten, at least eleven, or at least twelve analytes.

Illustrative embodiment 34B. The device of illustrative embodiment 34A, wherein each of the analytes is selected from the group consisting of glucose, bilirubin, ketones, blood, proteins, urobilinogen, nitrites, leukocytes, albumin, creatinine, ascorbic acid, specific gravity, and pH.

Illustrative embodiment 35. The device of any of illustrative embodiments 26-34B, wherein (e) is further defined as comprising at least 12 sample wells.

Illustrative embodiment 36. The device of any one of illustrative embodiments 26-35, wherein at least one colorimetric reagent present in at least one of the plurality of sample testing wells is selected from the group consisting of glucose oxidase, peroxidase, potassium iodide, 2,4-dichloroaniline diazonium salt, sodium nitroprusside, bromothymol blue, methyl vinyl ether, maleic anhydride, sodium hydroxide, diisopropylbenzene dihydroperoxide, 3, 3′, 5, 5′-tetramethylbenzidine, methyl red, tetrabromophenol blue, p-diethylamino-benzaldehyde, p-arsanilic acid, 1, 2, 3, 4-tetrahydrobenzo(h) quinolin-3-ol, derivatized pyrrole amino acid ester, bis (3′,3″-diiodo-4′,4″-dihydroxy-5′,5″-dinitrophenyl)-3,4,5,6-tetrabromosulfonepthalein, copper sulfate, and diazonium salt, or combinations thereof.

Illustrative embodiment 36A. The device of any one of illustrative embodiments 26-35, wherein the at least one colorimetric reagent present in at least two, at least three, at least four, at least five, at least six, at least seven, at least eight, at least nine, at least ten, at least eleven, or at least twelve of the plurality of sample testing wells is each independently selected from the group consisting of glucose oxidase, peroxidase, potassium iodide, 2,4-dichloroaniline diazonium salt, sodium nitroprusside, bromothymol blue, methyl vinyl ether, maleic anhydride, sodium hydroxide, diisopropylbenzene dihydroperoxide, 3, 3′, 5, 5′-tetramethylbenzidine, methyl red, tetrabromophenol blue, p-diethylamino-benzaldehyde, p-arsanilic acid, 1, 2, 3, 4-tetrahydrobenzo(h) quinolin-3-ol, derivatized pyrrole amino acid ester, bis (3′,3″-diiodo-4′,4″-dihydroxy-5′,5″-dinitrophenyl)-3,4,5,6-tetrabromosulfonepthalein, copper sulfate, and diazonium salt, or combinations thereof.

Illustrative embodiment 37. The device of any of illustrative embodiments 26-36A, wherein the device is structured and configured for positioning within a diagnostic instrument for optical interrogation of the sample wells.

Illustrative embodiment 38. The device of any of illustrative embodiments 26-37, wherein the at least one reagent present in at least one sample well is present at a volume of less than or equal to about 2.5 μl.

Illustrative embodiment 39. The device of any of illustrative embodiments 26-38, wherein the at least one reagent present in at least one sample well is in the form of a dried reagent.

Illustrative embodiment 40. The device of any of illustrative embodiments 26-39, wherein each of (f) and (h) has a diameter that is at least about twice a diameter of (e), to enable capillary action to pull sample into the sample wells and to inhibit progression of sample from the sample wells into the ventilation channel.

Illustrative embodiment 41. The device of any of illustrative embodiments 26-40, wherein (d) comprises a filter to inhibit debris from entering (f).

Illustrative embodiment 42. The device of any of illustrative embodiments 26-41, wherein the device has a width of less than or equal to about 1 cm.

Illustrative embodiment 43. The device of any of illustrative embodiments 26-42, wherein hydrophilic/phobic channel surface properties are present in the sample channel and sample wells.

Illustrative embodiment 44. A method of determining the presence of at least one target analyte in a fluidic biological sample, comprising the steps of: inserting a fluidic biological sample into the at least one sample collection well of the device of any of illustrative embodiments 26-43 and allowing the fluidic biological sample to flow through the device to the plurality of sample testing wells; and determining that at least one target analyte is present in the fluidic biological sample when a colorimetric result is observed at the sample well for the target analyte.

Illustrative embodiment 45. The method of illustrative embodiment 44, wherein the determining step is performed manually.

Illustrative embodiment 46. The method of illustrative embodiment 44, further comprising the step of positioning the device into a diagnostic instrument, and wherein the determining step comprises optical interrogation of the sample wells by the diagnostic instrument.

Illustrative embodiment 47. The method of any of illustrative embodiments 44-46, wherein the fluidic biological sample is selected from the group consisting of urine, whole blood or any portion thereof, synovial fluid, saliva, sputum, cerebrospinal fluid (CSF), intestinal fluid, intraperitoneal fluid, cystic fluid, sweat, interstitial fluid, extracellular fluid, tears, mucus, bladder wash, semen, fecal, pleural fluid, nasopharyngeal fluid, and combinations thereof.

Thus, in accordance with the present disclosure, there have been provided devices and kits, as well as methods of producing and using same, which fully satisfy the objectives and advantages set forth hereinabove. Although the present disclosure has been described in conjunction with the specific drawings, experimentation, results, and language set forth hereinabove, it is evident that many alternatives, modifications, and variations will be apparent to those skilled in the art. Accordingly, it is intended to embrace all such alternatives, modifications, and variations that fall within the spirit and broad scope of the present disclosure.

What is claimed is:

1. A laminated test strip device for detecting the presence of a plurality of target analytes in a biological sample, wherein the laminated test strip device is formed of a plurality of laminated layers of material that control sample flow and sample metering, the device comprising:
(i) a lower substrate layer, wherein a lower surface of the lower substrate layer forms a lower surface of the device;
(ii) at least a first interior layer;
(iii) at least a second interior layer;
(iv) an upper layer, wherein an upper surface of the upper layer forms an upper surface of the device;
(v) at least one sample collection well formed through the upper surface of (iv) and extending into (iii);
(vi) a plurality of sample testing wells, each having at least one colorimetric reagent dispensed therein in a metered volume, wherein the plurality of sample testing wells is formed within (ii);
(vii) a sample channel connecting (v) and (vi), wherein at least a portion of the sample channel is formed in (iii), and wherein the sample channel draws sample from the sample collection well into the plurality of sample testing wells via capillary action;
(viii) a venting well for receiving displaced air;
(ix) a venting channel connecting (vi) to (viii);
wherein at least a portion of each of (viii) and (ix) is independently formed in one or more layers other than (ii).

2. The device of claim 1, wherein at least a portion of (ix) is formed in layer (iii), and wherein at least a portion of (viii) is formed in layer (iii) and/or (iv).

3. The device of claim 1, wherein (iii) comprises at least two layers, and wherein at least a portion of (ix) is formed in both of the at least two layers of (iii), and wherein at least a portion of (viii) is formed in one or more of layer (iv) and the at least two layers of (iii).

4. The device of claim 1, further defined as comprising at least one additional interior layer between layers (i) and (ii).

5. The device of claim 4, wherein at least a portion of (vii), (viii), and/or (ix) is formed in the at least one additional layer between (i) and (ii).

6. The device of claim 1, wherein at least layers (iii) and (iv) are formed of a substantially transparent material.

7. The device of claim 1, wherein each layer has a thickness in a range of from about 0.1 mm to about 1 mm.

8. The device of claim 1, wherein the device has a total thickness in a range of from about 0.4 mm to about 4 mm.

9. The device of claim 1, wherein each of layers (iii) and (iv) is formed of a material independently selected from the group consisting of acrylic, polystyrene, styrene-acrylonitrile, polycarbonate, polyethylene terephthalate, and any combination thereof.

10. The device of claim 1, wherein the device is configured for use with a fluidic biological sample selected from the group consisting of urine, whole blood or any portion thereof, synovial fluid, saliva, sputum, cerebrospinal fluid (CSF), intestinal fluid, intraperitoneal fluid, cystic fluid, sweat, interstitial fluid, extracellular fluid, tears, mucus, bladder wash, semen, fecal, pleural fluid, nasopharyngeal fluid, and combinations thereof.

11. The device of claim 10, further defined as a laminated urinalysis test strip device.

12. The device of claim 1, wherein the plurality of target analytes comprises at least two analytes, wherein each of the at least two analytes is selected from the group consisting of glucose, bilirubin, ketones, blood, proteins, urobilinogen, nitrites, leukocytes, albumin, creatinine, ascorbic acid, specific gravity, and pH.

13. The device of claim 1, wherein (vi) is further defined as comprising at least 12 sample wells.

14. The device of claim 1, wherein at least one colorimetric reagent present in at least one of the plurality of sample testing wells is selected from the group consisting of glucose oxidase, peroxidase, potassium iodide, 2,4-dichloroaniline diazonium salt, sodium nitroprusside, bromothymol blue, methyl vinyl ether, maleic anhydride, sodium hydroxide, diisopropylbenzene dihydroperoxide, 3, 3′, 5, 5′ tetramethylbenzidine, methyl red, tetrabromophenol blue, p-diethylamino-benzaldehyde, p-arsanilic acid, 1, 2, 3, 4-tetrahydrobenzo(h) quinolin-3-ol, derivatized pyrrole amino acid ester, bis (3′, 3″-diiodo-4′, 4″-dihydroxy-5′, 5″-dinitrophenyl) 3, 4, 5, 6-tetrabromosulfonepthalein, copper sulfate, and diazonium salt, or combinations thereof.

15. The device of claim 1, wherein the device is structured and configured for positioning within a diagnostic instrument for optical interrogation of the sample wells.

16. The device of claim 1, wherein the at least one reagent present in at least one sample well is present at a volume of less than or equal to about 2.5 μl.

17. The device of claim 1, wherein the at least one reagent present in at least one sample well is in the form of a dried reagent.

18. The device of claim 1, wherein each of (vii) and (ix) has a diameter that is at least about twice a diameter of (vi), to enable capillary action to pull sample into the sample wells and to inhibit progression of sample from the sample wells into the ventilation channel.

19. The device of claim 1, wherein (v) comprises a filter to inhibit debris from entering (vii).

20. The device of claim 1, wherein the device has a width of less than or equal to about 1 cm.

21. The device of claim 1, wherein hydrophilic/phobic channel surface properties are present in the sample channel and sample wells.

22. A method of determining the presence of at least one target analyte in a fluidic biological sample, comprising the steps of:
inserting a fluidic biological sample into the at least one sample collection well of the device of claim 1 and allowing the fluidic biological sample to flow through the device to the plurality of sample testing wells; and
determining that at least one target analyte is present in the fluidic biological sample when a colorimetric result is observed at the sample well for the target analyte.

23. The method of claim 22, wherein the determining step is performed manually.

24. The method of claim 22, further comprising the step of positioning the device into a diagnostic instrument, and wherein the determining step comprises optical interrogation of the sample wells by the diagnostic instrument.

25. The method of claim 22, wherein the fluidic biological sample is selected from the group consisting of urine, whole blood or any portion thereof, synovial fluid, saliva, sputum, cerebrospinal fluid (CSF), intestinal fluid, intraperitoneal fluid, cystic fluid, sweat, interstitial fluid, extracellular fluid, tears, mucus, bladder wash, semen, fecal, pleural fluid, nasopharyngeal fluid, and combinations thereof.

26. A laminated test strip device for detecting the presence of a plurality of target analytes in a biological sample, wherein the laminated test strip device is formed of a plurality of laminated layers of material that control sample flow and sample metering, the device comprising:
(a) a lower substrate layer, wherein a lower surface of the lower substrate layer forms a lower surface of the device;
(b) at least one interior layer; and
(c) an upper layer, wherein an upper surface of the upper layer forms an upper surface of the device;
(d) at least one sample collection well formed through the upper surface of (c) and extending into (b);
(e) a plurality of sample testing wells, each having at least one colorimetric reagent dispensed therein in a metered volume, wherein the plurality of sample testing wells is formed within (b);
(f) a sample channel connecting (d) and (e), wherein at least a portion of the sample channel is formed in (b), and wherein the sample channel draws sample from the sample collection well into the plurality of sample testing wells via capillary action;
(g) a venting well for receiving displaced air, wherein at least a portion of the venting well is formed in (b); and
(h) a venting channel connecting (e) to (g).
